(19) United States
(12) Patent Application Publication
(10) Pub. No.: US 2002/0160789 A1
(43) Pub. Date: Oct. 31, 2002

(54) Method for providing location information

(76) Inventor: Andreas Berg, Berlin (DE)

Correspondence Address: BELL, BOYD & LLOYD, LLC, P. O. BOX 1135, CHICAGO, IL, 60690-1135, US

(21) Appl. No.: 10/018,816

(22) PCT Filed: Mar. 14, 2001
(86) PCT No.: PCT/DE01/00967

(30) Foreign Application Priority Data
Apr. 17, 2000 (DE) 100 18 999.7

(51) Int. Cl. H04Q 7/20

(52) U.S. Cl. 455/456; 455/433; 455/435

(57) ABSTRACT

In MTCS, it may be necessary to identify the location of the B-subscriber as precisely as possible. The location information is determined in the following steps:

a) A first message is addressed by the SCP and dispatched to the required terminal. This first message is forwarded by the Visitor Location Register and simultaneously initiates an update of the location information contained in the Visitor Location Register, insofar as the subscriber identification was successful. The location information includes an indication of when this location information was identified/created. This age information is similarly updated.

b) A second message is then dispatched. By means of this message, the Service Control Point then interrogates the stored location information and age information in the Visitor Location Register. The age information indicates whether the supplied location information is up-to-date.

c) If the determined location information is identified as up-to-date, it is evaluated by the Service Control Point and used for further purposes, for example a location-dependent MTC-IN service.

### TECHNICAL FIELD OF THE INVENTION

Location-dependent IN services are becoming increasingly important. For MTC IN services (MTC—Mobile Terminating Call, calls to a subscriber of a mobile telephone network, IN—Intelligent Network), which evaluate the location of the called B-subscriber, maximum accuracy may be required in determining the location of the IN customer. The precise location information, e.g. in the form of a “location area” and a “serving cell ID” (i.e. the cell of the cellular-structure telephone network in which a subscriber is currently located) of the B-subscriber is intended to be determined for the IN service process.

### STATE OF THE ART

Hitherto, only the VLR (Visitor Location Register) number has been available to the Service Control Point (SCP) of an intelligent network IN for MTCs via an “AnyTimeInterrogation” (ATI, which is described in the GSM 03.78 standard) or a “StandardInterrogation”. This location information is too inaccurate from most IN applications, since one VLR number represents the entire coverage area of an MSC (Mobile Switching Center, switching station in a mobile radio network). If the Visitor Location Register VLR is also interrogated, for example with the “ProvideRoamingNumber” or “ProvideSubscriberInfo” commands, more accurate location information, e.g. the “Cell ID” and/or “Location Area Identity” (LAI), “Location Number” (LN), is available, but it originates from the last contact with the mobile telephone.

The age of this information is stored in the parameter set under “AgeOfLocationInformation”. This value can be used in an IN service to decide whether the location can still be used, or is already too old. However, this information cannot be used to obtain more up-to-date location information.

The current “Cell ID” and “Location Number” for the MTC service can currently be evaluated in the post-processing of charge tickets only, but not by the IN service, directly before the telephone call.

In MTCs, it may be necessary to identify the location of the B-subscriber as precisely as possible. If the “Service Cell ID” information and the “Location Area” can be precisely defined and reported to the Service Control Point SCP, location-dependent MTC-IN services can respond with maximum granularity to the location of the B-subscriber. Thus, new telecommunications services can be offered for which precise location information is necessary.

Further, very costly, solutions are under consideration for location definition. However, these mean that the network operator must equip the network with a highcost infrastructure (for example “Time of Arrival” or “Enhanced Observed Time Difference”), or must adapt the terminals, i.e. the mobile telephones, for example with a “SIM Application Toolkit” or with other known location information systems such as the Global Positioning System GPS. These methods can locate a terminal in a telecommunications network more accurately, but the financial and technical outlay required in order to obtain this more accurate information is considerable.

The object of the invention is to determine more accurate location information with minimal outlay. A further object of the invention is to make more accurate location information available to an IN service.

### PRESENTATION OF THE INVENTION

This object is achieved by determining this location information in the following steps:

a) A first message is addressed by the SCP and dispatched to the required terminal. This first message is forwarded by the Visitor Location Register and simultaneously initiates an update of the location information contained in the Visitor Location Register, insofar as a subscriber identification was successful. The location information includes an indication of when this location information was identified/created. This age information is similarly updated.

b) A second message is then likewise dispatched by the Service Control Point. By means of this message, the Service Control Point then interrogates the stored location information and age information in the Visitor Location Register. The age information indicates whether the supplied location information is up-to-date.

c) If the determined location information is identified as up-to-date, it is evaluated by the Service Control Point and used for further purposes, for example a location-dependent MTC-IN service.

d) Otherwise, it can be inferred that the called mobile radio subscriber is not currently available. This may trigger different responses from the service.

Messages which can be used in this way are already individually known in mobile radio networks, but no combination of the type according to the invention has hitherto been carried out in order to thus obtain location information of the B-subscriber for the Service Control Point (or the Visitor Location Register).

Further embodiments of the invention can be found in the subclaims.

In a first embodiment, the second message is initiated by the first message at a definable time interval (for example in seconds) in order to ensure that the first message had enough time to be delivered to the recipient and, above all, to initiate the required updates of the location information in the Visitor Location Register.

In a further advantageous embodiment of the invention, the content of the first message is empty. This means that no content is transferred to the B-subscriber addressed in this way, but this message is used purely to determine the location information which is normally required by the service provider.

Furthermore, the Service Control Point, following the evaluation of the location information and, above all, its age, can decide that the procedure needs to the repeated, and can first repeat the first message and then interrogate the location information again by means of the second message.

### BRIEF DESCRIPTION OF THE DRAWINGS

FIG. 1 shows a schematic representation of the network elements affected by the interrogation initiated by the Service Control Point SCP, and the information flow of messages between these network elements, and

FIG. 2 shows a flow chart of the method according to the invention, and

FIG. 3 shows a second flow chart.

### DESCRIPTION OF FURTHER EMBODIMENTS

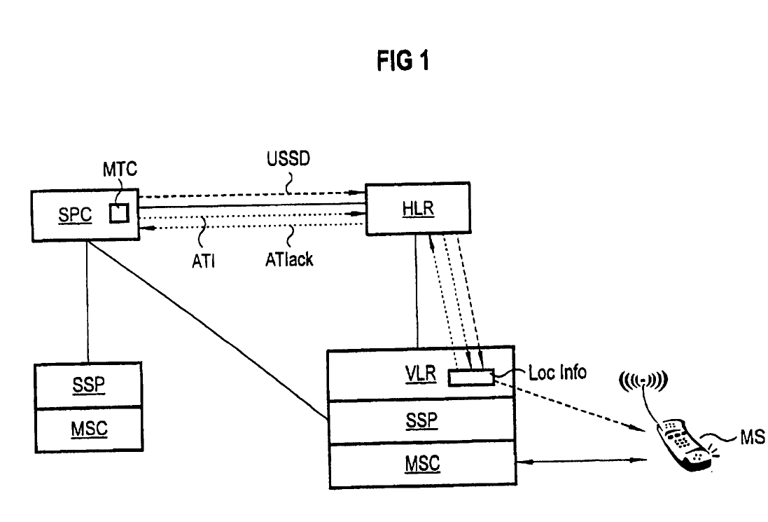

FIG. 1 shows those elements of a mobile radio network which are required for the performance of an MTC-IN service. In this embodiment, the underlying cellular mobile radio network is based on the GSM standards, but this does not represent a restriction to the method according to the invention.

In this example, the service program (referred to as the service logic) MTC is available in executable form in a Service Control Point SCP. The tasks to be performed by the Service Control Point SCP in an intelligent network include fast conversion of a first telephone number into a destination telephone number (address), running of applications, reception (from the SSP) and forwarding of connection information and the charge recording system.

The Mobile Switching Centre MSC serves as the connection controller to and from the mobile subscriber MS located in the MSC area. The integrated MSC functions correspond to those of the Service Switching Point SSP and the processing functions of the Service Control Point SCP in an intelligent network IN.

The database facilities HLR and VLR are location registers which contain all the individual subscriber data which are relevant to service usage. These location registers are similarly also used for ISDN, PSTN, PCN or UMTS.

The Home Location Register HLR contains all semi-permanent and temporary data: subscriber information and operational features which are important for a connection. They include the database for system control of the service processes and their administration, providing the central master database. The data in the HLR are relevant above all to the connection set-up. The address of the current Visitor Location Register VLR is also stored in the HLR.

The Visitor Location Register VLR is a local database which contains the subset of the data relating to subscribers located in its area, including the current location LocInfo, which are important for call-processing functions (i.e. connection processing). The data are dynamically updated by the terminals (MS) and by the HLR, particularly during roaming.

The HLR and VLR can exchange data with the aid of the MAP protocol (Mobile Application Part, see also the GSM 09.02), also for the MSCs.

In order to send the first message with the aim of updating the location information LocInfo in the Visitor Location Register VLR, a USSD message, which may be an empty “dummy” message, for example “**666#”, is transmitted by the SCP. Here, “666” is the service code for the dummy string, and this is not followed by any further information.

A description of USSD messages can be found in the GSM 03.90 specification. In particular, it is possible for the USSD message to be initiated by the SCP (“Network initiated unstructured supplementary service”), without a mobile radio subscriber having previously transmitted a corresponding USSD message.

The HLR forwards the USSD to the VLR/MSC in which the mobile radio subscriber MS had its last contact with the network. There, the network attempts to forward the USSD to the mobile radio subscriber, i.e. it performs a paging operation. If the location is successfully determined, the location information LocInfo is updated in the Visitor Location Register VLR. In the event of failure, the dispatch of the USSD message can be repeated. If the USSD message cannot be delivered, this step is omitted, and the location information is not updated.

A second message is then transmitted by the service MTC to interrogate the updated location information. The “AnyTimeInterrogation” ATI of the MAP protocol, for example, can be used for this purpose. The HLR forwards the ATI to the VLR (Provide_Subscriber_Information). It then supplies as a reply ATIack the location information LocInfo which is stored in the VLR and also AgeOfLocationlnformation,which indicates the age of the information.

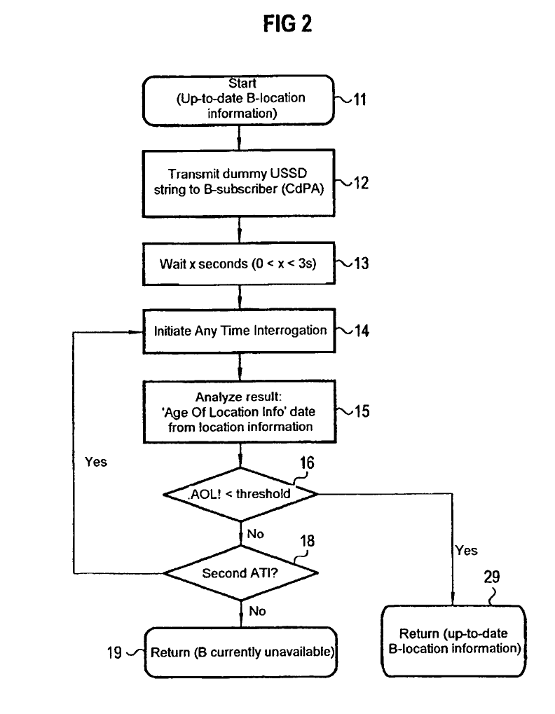

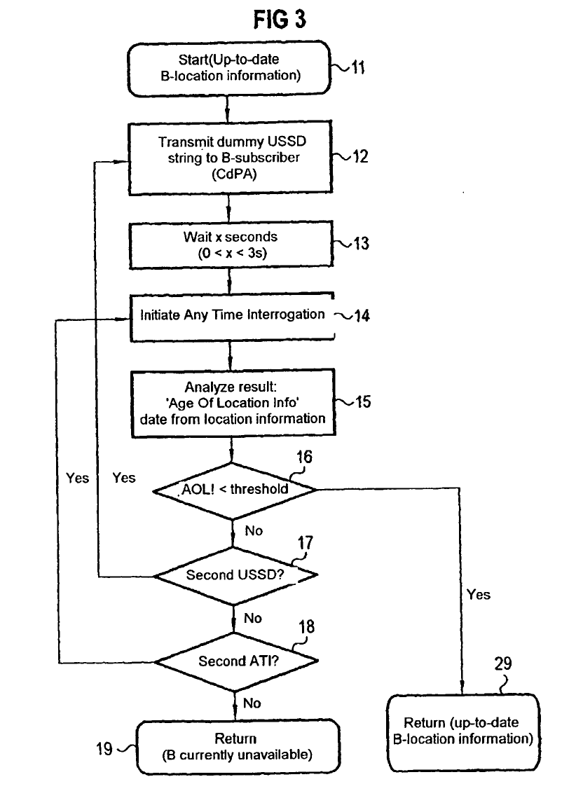

FIG. 2 and FIG. 3 illustrate the process in a flow chart. This is based on a situation in which a requirement exists for up-to-date location information for a subscriber, 11. As already explained above, a USSD message is then transmitted to the required subscriber, 12. This is followed by a (definable) period, in this example up to 3 seconds, 13. After this period, the second message, an ATI interrogation, is initiated, 14. The location information contained in the reply is examined for its age, AgeOfLocationInformation AOLI, 15. It is, for example, compared with a threshold value, 16. If the information is sufficiently up-to-date, the determined location information is recognized as up-to-date location information and is delivered back, for example to the MTC service, 29. Otherwise, an interrogation can again be optionally dispatched, 18, or in the first instance a second USSD, 17. If all this fails, the sought subscriber is marked as currently unavailable.

This method offers the advantage that location information which, in most cases (i.e. for most MTC services), is sufficiently accurate can be obtained even without the implementation of additional expensive technologies. For example, the required “Network Initiated USSD” is available to the SCP as from Siemens Switch Release SR9.

### LITERATURE

GSM 09.02 (ETSI TS 100 974)

Digital cellular telecommunication system (phase 2+);

Mobile Application Part (MAP) specification

Version 7.1.0 Release 1998

GSM 03.90 (ETSI TS 100 549)

Digital cellular telecommunication system (phase 2+); Unstructured Supplementary Service Data (USSD) Stage 2

Version 7.0.0 Release 1998

GSM 03.78 (ETSI TS 101 441)

Digital cellular telecommunication system (phase 2+);

Customized Applications for Mobile network Enhanced Logic (CAMEL) Phase 2; Stage 2

Version 6.4.0 Release 1997

List of Abbreviations

ATI AnyTimeInterrogation

HLR Home Location Register

IN Intelligent Network

LocInfo Location Information

MAP Mobile Application Part

MS Mobile Station (mobile telephone)

MSC Mobile Switching Center

MTC Mobile Terminating Call

PCN Personal Communication Network

SCP Service Control Point

UMTS Universal Mobile Telecommunications System

SSP Service Switching Point

USSD Unstructured Supplementary Service Data

VLR Visitor Location Register

1. A method for providing information on the current location of a terminal (MS) for a telecommunications service in a mobile radio network, in which at least one Mobile Switching Center (MSC) with a Visitor Location Register (VLR) exists, in which
a first message (USSD) is transmitted by the Service Control Point (SCP) to the terminal (MS), and
the location information is checked in the Visitor Location Register,
a second message (ATI) is transmitted by the Service Control Point (SCP) to the Visitor Location Register (VLR),
the Visitor Location Register (VLR) sends a reply (ATIack) to the Service Control Point (SCP), containing location information and an indication of the age of this location information,
the telecommunications service evaluates the location information contained in received reply from the terminal.

2. The method for providing location information for a telecommunications service as claimed in claim 1, characterized in that the second message is transmitted a definable time after the first message.

3. The method as claimed in claim 1 or 2, characterized in that the first message (USSD) is empty.

4. The method as claimed in one of the previous claims, characterized in that
first message (USSD) is forwarded to the Mobile Switching Center (MSC) with the Visitor Location Register (VLR), with which the terminal (MS) had the last contact with the telecommunications network, and
this Mobile Switching Center attempts to forward the first message to the terminal (MS), and
if the forwarding is successful, the location information (LocInfo) entry is updated in the Visitor Location Register.

5. The method as claimed in one of the previous claims, characterized in that
the location information contained in the reply (ATIack) is not up-to-date, and
at least the second message (ATI) is retransmitted.
